(19) United States
(12) Patent Application Publication
(10) Pub. No.: US 2007/0188820 A1
(43) Pub. Date: Aug. 16, 2007

(54) MULTI-FUNCTION PRINTER

(75) Inventor: Ying-Qi Zhu, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/674,656

(22) Filed: Feb. 13, 2007

(30) Foreign Application Priority Data
Feb. 14, 2006 (TW) TW95104886

(51) Int. Cl. H04N 1/00

(52) U.S. Cl. 358/401; 358/296

(57) ABSTRACT

A multi-function printer comprises a printing module, a scanning module, a supporter and a cam. The printing module has an accommodation portion and a supporting groove. The scanning module is rotatably disposed on the printing module. The supporter is rotatably disposed on the scanning module. The cam is rotatably disposed in the accommodation portion and capable of rotating between a first position and a second position. When the scanning module is rotated and opened, the cam rotates and guides the supporter to abut the supporting groove, whereby the scanning module is supported on the printing module. When the scanning module is rotated and closed, the cam rotates and guides the supporter to enter the accommodation portion.

### BACKGROUND OF THE INVENTION

1. Field of the Invention

The invention relates to a multi-function printer, and in particular to a multi-function printer with a scanning module operable by a single hand.

2. Description of the Related Art

Referring to FIG. 1a a conventional multi-function printer 10 comprises a scanning module 5 and a printing module 7. The scanning module 5 is rotatably disposed on the printing module 7. In FIG. 1b, the scanning module 5 is open. When the scanning module 5 is open, a supporter 6 engages a groove (not shown) in the printing module 7, whereby the scanning module 5 is supported and positioned on the printing module 7. When the scanning module 5 is about to be closed, the scanning module 5 must be held by one hand and the supporter 6 pulled from the groove by the other hand. In such a structure, the scanning module 5 is closed by two hands. In such a condition, the operation is complicated and may cause security problem. When improperly operated, especially when the user replace the ink cartridge, the hand may be hurt by the falling scanning module 5.

### BRIEF SUMMARY OF THE INVENTION

An embodiment of a multi-function printer of the invention comprises a printing module, a scanning module, a supporter and a cam. The printing module has a accommodation portion and a supporting groove. The scanning module is rotatably disposed on the printing module. The supporter is rotatably disposed on the scanning module. The cam is rotatably disposed in the accommodation portion and capable of rotating between a first position and a second position. When the scanning module is rotated and opened, the cam rotates and guides the supporter to abut the supporting groove, whereby the scanning module is supported on the printing module. When the scanning module is rotated and closed, the cam rotates and guides the supporter to enter the accommodation portion.

The cam has a first guide surface and a second guide surface. When the scanning module is rotated and opened, the supporter slides on the first surface to abut the supporting groove. When the scanning module is rotated and closed, the supporter, slides on the second guide surface to enter the accommodation portion. The first guide surface is adjacent to the second guide surface.

The cam further comprises a first against surface adjacent to the first guide surface and a second against surface adjacent to the second guide surface. When the scanning module is rotated and opened, the supporter slides from the first guide surface to the first against surface to rotate the cam to the first position, whereby the supporter is guided to abut the supporting groove. When the scanning module is rotated and closed, the supporter slides from the second guide surface to the second against surface to rotate the cam to the second position, whereby the supporter is guided to enter the accommodation portion.

The cam further comprises a first positioning surface and a second positioning surface. When the supporter is positioned in the supporting groove, the cam rotates to the first position and the first positioning surface abuts the accommodation portion. When the supporter is guided to abut the accommodation portion, the cam rotates to the second position and the second positioning surface abuts the accommodation surface.

The first positioning surface is adjacent to the first against surface, and the second positioning surface is adjacent to the second against surface.

The multi-function printer further comprises an elastic element connecting the cam and the accommodation portion, wherein when the cam rotates to the first position, the first positioning surface abuts the accommodation portion by the elastic element, and when the cam rotates to the second position, the second positioning surface abuts the accommodation portion by the elastic element. The elastic element can be an extension spring.

The cam further comprises a positioning element, and the accommodation portion comprises a first groove and a second groove corresponding to the first position and the second position respectively. When the cam rotates to the first position, the positioning element engages the first groove, whereby the first positioning surface abuts the accommodation portion. When the cam rotates to the second position, the positioning element engages the second groove, whereby the second positioning surface abuts the accommodation portion.

The positioning element is a protrusion projecting from the cam.

The accommodation portion is adjacent to the supporting groove.

The accommodation portion comprises a first accommodation portion and a second accommodation portion under the first accommodation portion. The supporter is accommodated in the first accommodation portion and the cam is accommodated in the second accommodation portion with a axle.

The second accommodation portion comprises a first surface and a second surface corresponding to the first positioning surface and the second positioning surface, and when the cam is in the first position, the first positioning surface abuts the first surface, and when the cam is in the second position, the second positioning surface abuts the second surface.

### BRIEF DESCRIPTION OF THE DRAWINGS

The invention can be more fully understood by reading the subsequent detailed description and examples with references made to the accompanying drawings, wherein:

FIGS. 1a and 1b depict a conventional multi-function printer;

FIG. 2 is a perspective view of an embodiment of a multi-function printer of the invention, wherein the scanning module is closed;

FIG. 3 is another perspective view of an embodiment of a multi-function printer of the invention, wherein the scanning module is open;

FIG. 4 is an exploded view of an embodiment of a multi-function printer of the invention;

FIG. 5a is a perspective view of the cam of the invention;

FIG. 5b is another perspective view of the cam of the invention;

FIG. 5c is a side view of the cam of the invention;

FIG. 6a is a perspective view of the printing module of the invention;

FIG. 6b is a cross section of the printing module of the invention;

FIGS. 7˜12b depict the scanning module being opened;

FIGS. 13˜17 depict the scanning module being closed;

FIGS. 18a and 18b are perspective views of another embodiment of a multi-function printer of the invention; and

FIGS. 19a and 19b depict the scanning module of another embodiment of a multi-function printer of the invention.

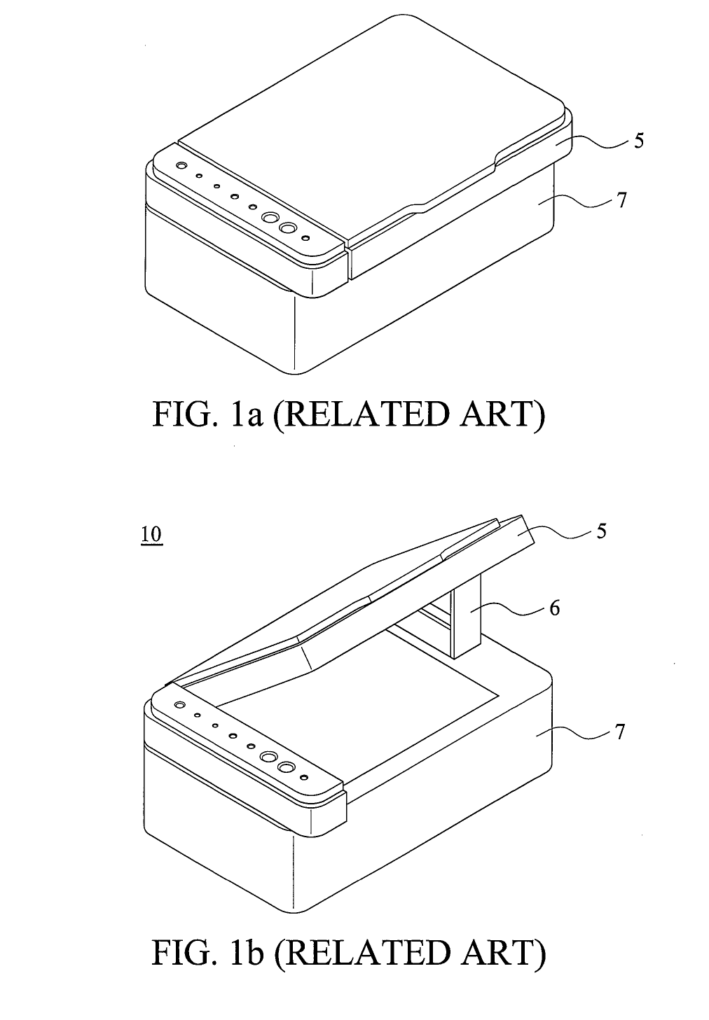

### DETAILED DESCRIPTION OF THE INVENTION

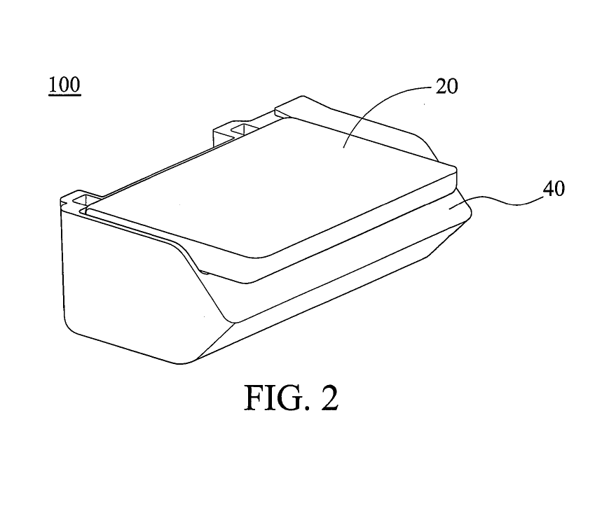

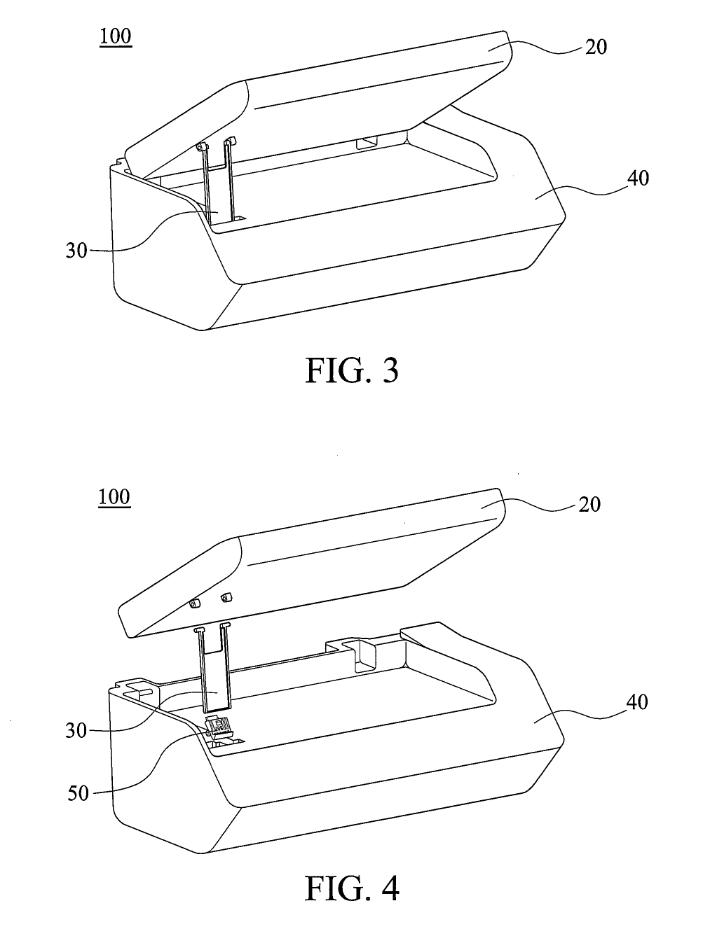

Referring to FIGS. 2, 3 and 4, an embodiment of a multi-function printer 100 of the invention comprises a scanning module 20, a supporter 30, a printing module 40 and a cam 50. The scanning module 20 is rotatably disposed on the printing module 40. The supporter 30 can be accommodated in the printing module 30. When the scanning module 20 is rotated and opened, the supporter 30 supports and positions the scanning module 20 to the printing module 30. The scanning module 20 is positioned by an predetermined angle with respect to the printing module 30. The cam 50 is disposed in the printing module 30 to guide the supporter 30 to a predetermined position to support the scanning module 20 or to guide the supporter 30 to be accommodated in the printing module 30.

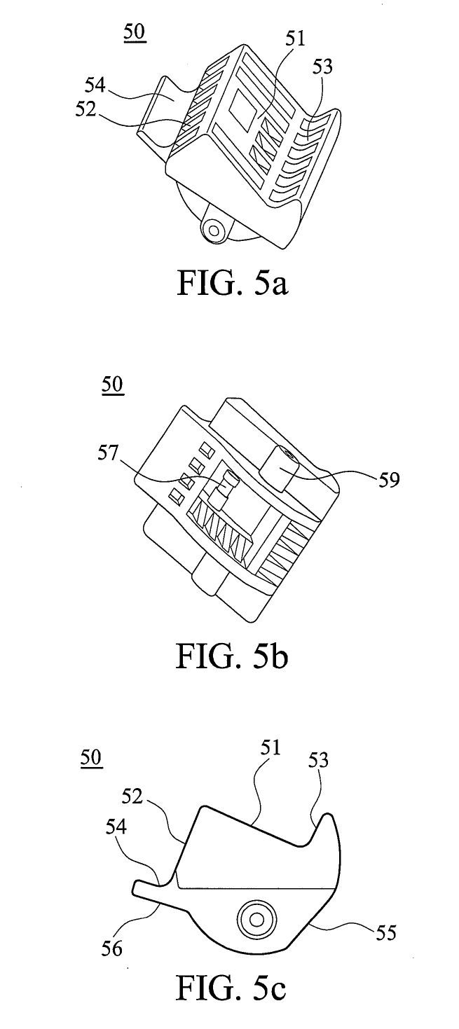

Referring to FIGS. 5a, 5b and 5c, the cam 50 is rotatably disposed in an accommodation portion of the printing module 30 with respect to a shaft 59 and rotatable between a first position and a second position. The cam 50 has a first guide surface 51, a second guide surface 52, a first against surface 53, a second against surface 54, a first positioning surface 55 and a second positioning surface 56. The first guide surface 51 is adjacent to the second guide surface 52. The first against surface 53 is an inclined surface adjacent to the first guide surface 51, and the second against surface is an inclined surface adjacent to the second guide surface 52. The first positioning surface 55 is on the bottom of the cam 50 and near the first against surface 53, and the same with the second position surface 56, it is on the bottom of the cam 50 too and near the second against surface 54. The functions of the surfaces of the cam 50 are described later. The cam 50 further comprises a first post 57.

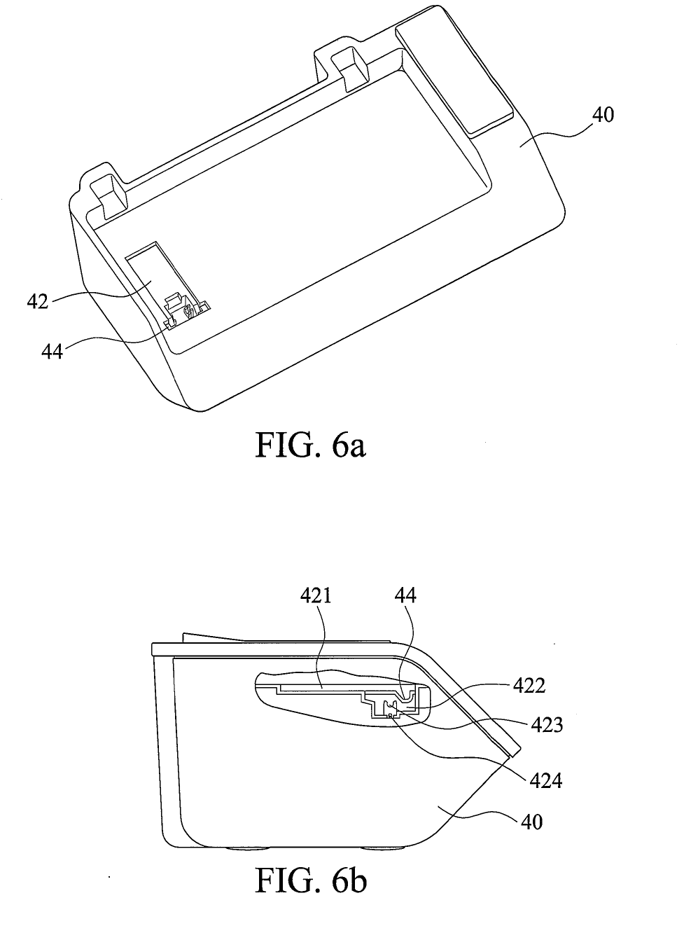

Because the cam 50 is disposed in the printing module 40, the structure of the printing module 40 is described. FIG. 6a is a perspective view of the printing module 40. The printing module 40 comprises an accommodation portion 42 and a supporting groove 44. When the scanning module 20 is closed, the accommodation portion 42 accommodates the supporter 30 and the cam 50. When the supporter 30 supports the scanning module 20, the supporting groove 44 positions the supporter 30 on the printing module 40. The supporting groove 44 is adjacent to the accommodation portion 42. Referring to FIG. 6b, the accommodation portion comprises a first accommodation portion 421 and a second accommodation portion 422. The first accommodation portion 421 accommodates the supporter 30, and the second accommodation portion is used to accommodate the cam 50. A shaft seat 423 is disposed in the second accommodation portion 422 for the shaft 59 of the cam 50 (shown in FIG. 5b), whereby the cam 50 is rotatably disposed in the second accommodation portion 422. The first accommodation portion 421 is adjacent to the second accommodation portion 422. The second accommodation portion 422 further comprises a second post 424 corresponding to the first post 57. An extension spring 60 connects the first post 57 and the second post 424.

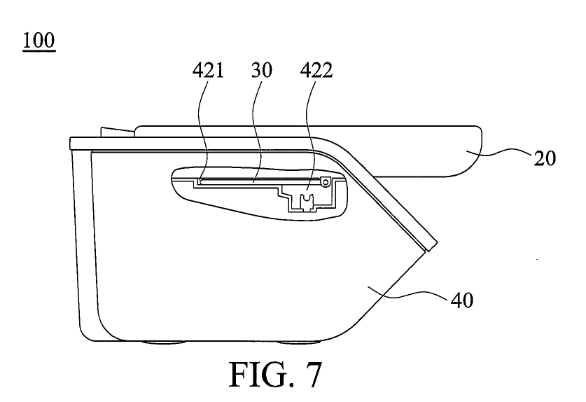

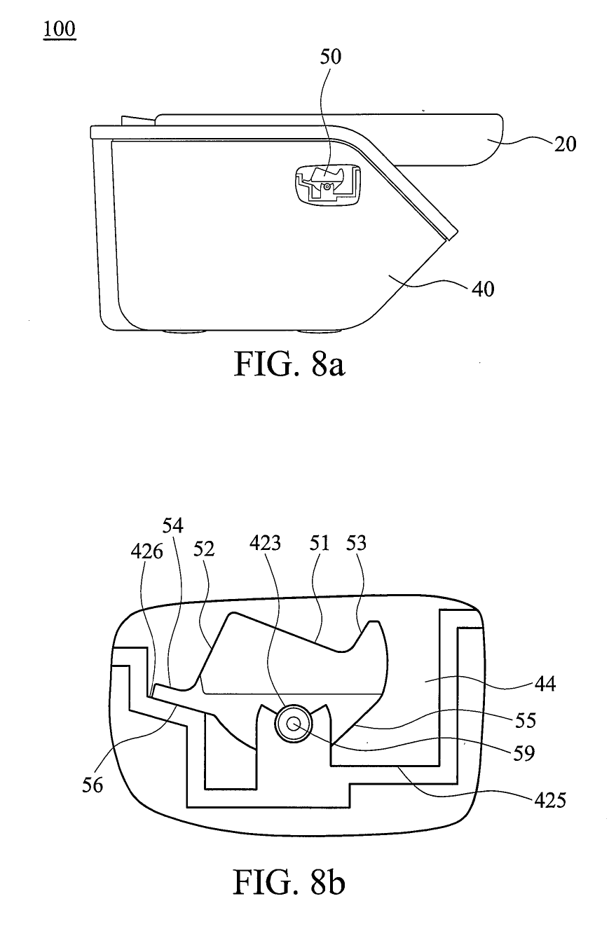

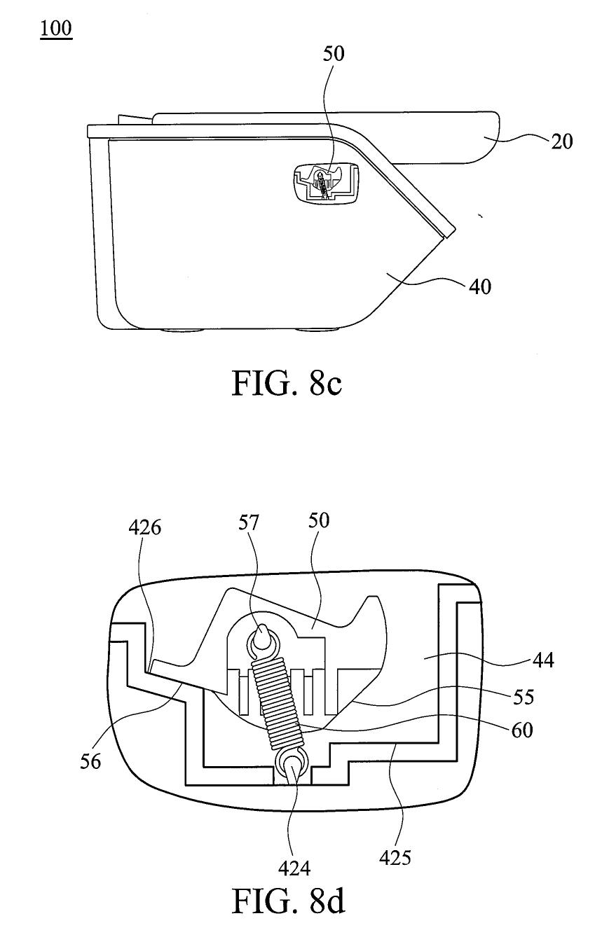

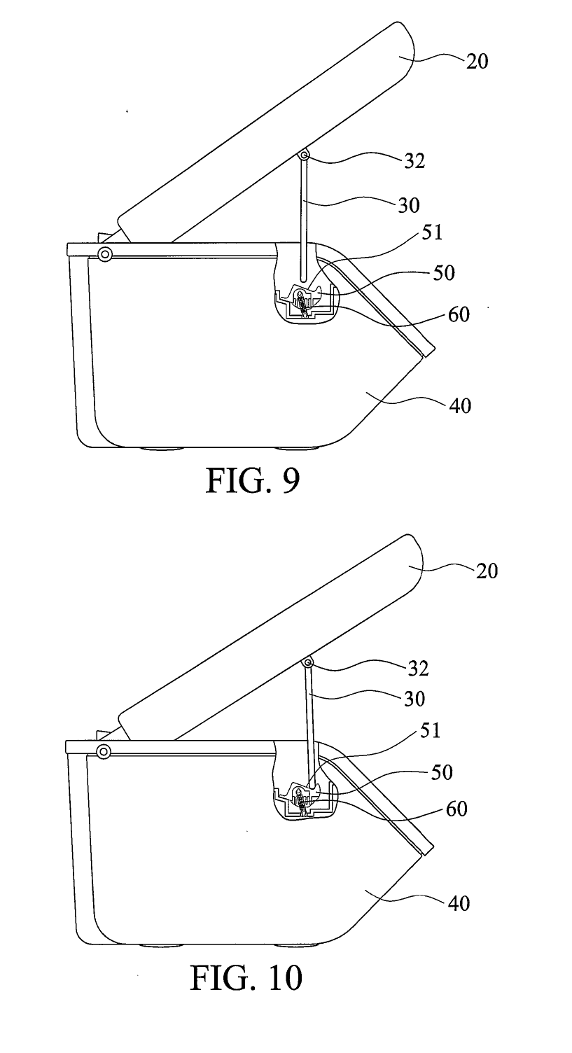

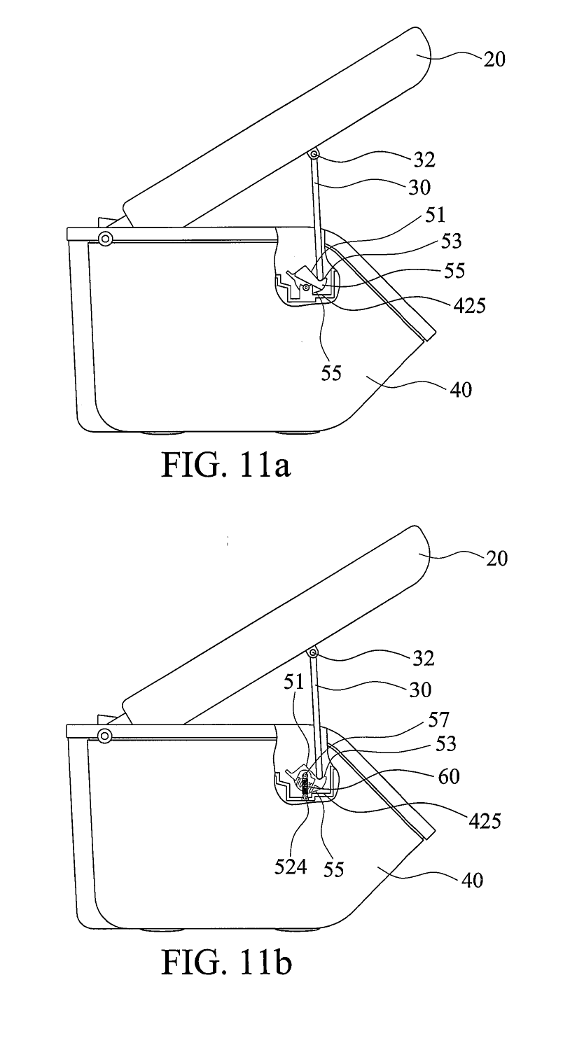

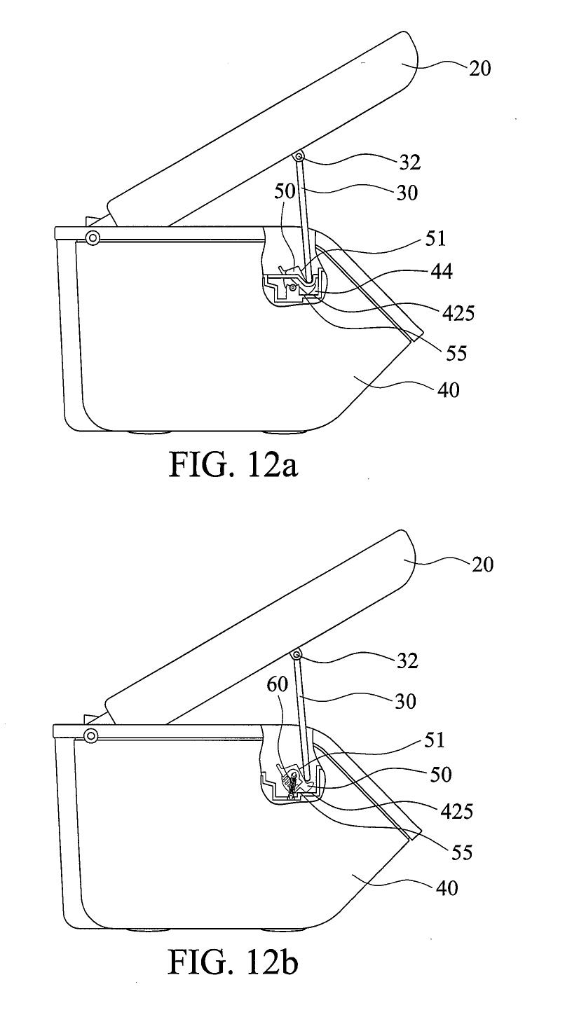

FIG. 7 is a schematic view showing the scanning module 20 closed and covering the printing module 40. The supporter 30 is accommodated in the first accommodation portion 421. FIGS. 8a˜8d depict the cam 50 when the scanning module 20 is closed and covers the printing module 40. In FIGS. 8b and 8d, when the scanning module 20 is closed, the second positioning surface 56 of the cam 50 is abutted by a second surface 426 of the second accommodation portion 422 by the extension spring 60. At this time, the cam 50 is in the second position.

FIGS. 9˜17 depict the scanning module 20. When the scanning module 20 is opened to a maximum angle shown in FIG. 9, the supporter 30 escapes from the first accommodation portion 421 and rotates to a vertical position with respect to a shaft 32. At this time, the free end of the supporter 30 is aligned with the first guide surface 51. The scanning module 20 descends to contact the first guide surface 51 and slides along the first guide surface 51 to contact the first against surface 53 as shown in FIG. 10. The scanning module 20 keeps descending, and the supporter 30 abuts the first against surface 53 and rotates cam 50 as shown in FIG. 11. At this time, the extension spring 60 is pulled to its maximum length, and the first post, shaft 59 and second post 424 are lined. The scanning module 20 keeps descending as shown in FIGS. 12a and 12b. The extension spring 60 pulls the cam 50 to rotate to the first position where the first positioning surface 55 abuts a first surface 425 (shown in FIGS. 8b and 8d) of the second accommodation portion 422. At this time, the supporter 30 is guided to the supporting groove 44 and positioned on the printing module 40, whereby the scanning module 20 is supported on the printing module 40.

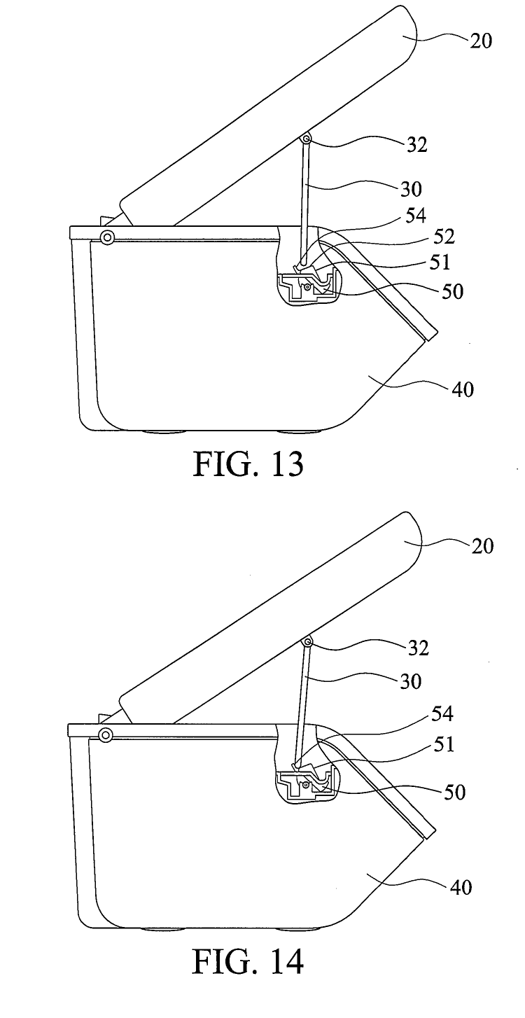

When the scanning module 20 is to be closed, the scanning module 20 is lifted further to a maximum angle by a single hand as shown in FIG. 13. The supporter 30 returns to the vertical position due to gravity. At this time, as the cam 50 is still in the first position, the free end of the supporter 30 is aligned with the second guide surface 52. When the scanning module 20 is lifted to the maximum angle and set free, the scanning module 20 rotates and descends due to gravity. The free end of the supporter 30 descends to contact the second positioning surface 52 and slides on the second positioning surface 52 to contact the second against surface 54 as shown in FIG. 14. The scanning module 20 keeps descending, and the supporter 30 abuts the second against surface 54 to rotate the cam 50 as shown in FIG. 15. At this time, the extension spring 60 is pulled. When the extension spring 60 exceeds a maximum length, the cam 50 is pulled back to the second position by the extension spring 60, where the second positioning surface 56 abuts the second surface 426. At this time, the free end of the supporter 30 is guided into the first accommodation portion 421, and the supporter 30 is accommodated in the first accommodation portion 421 as shown in FIG. 17.

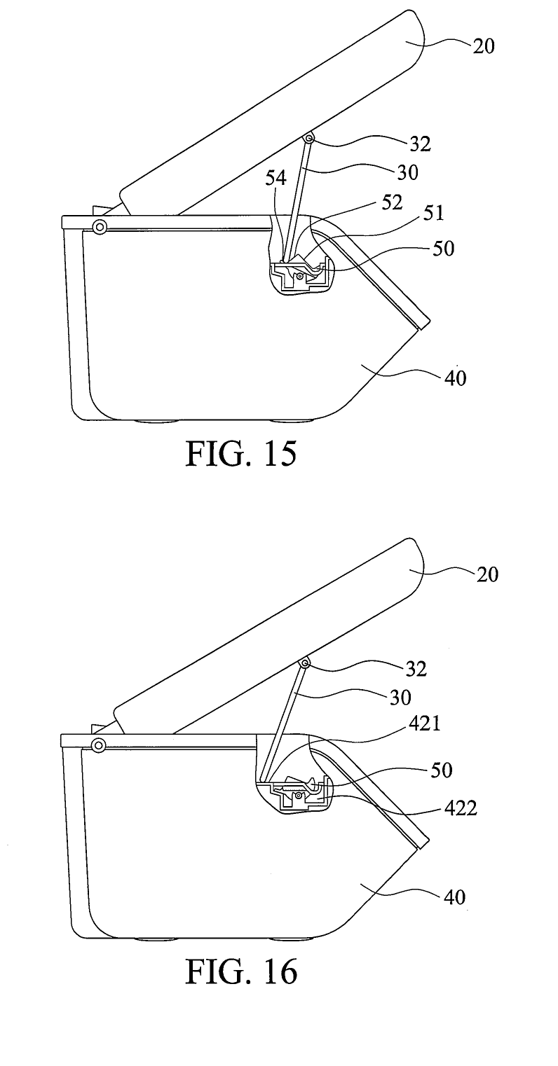

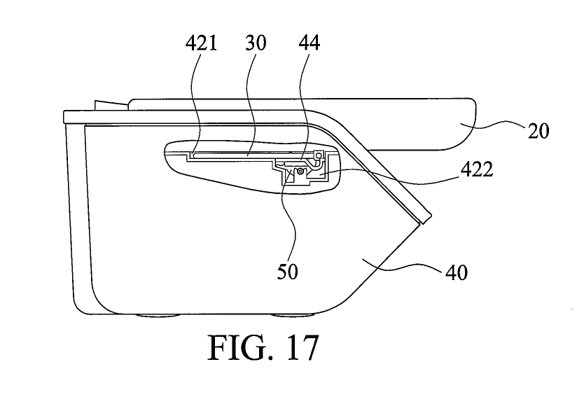

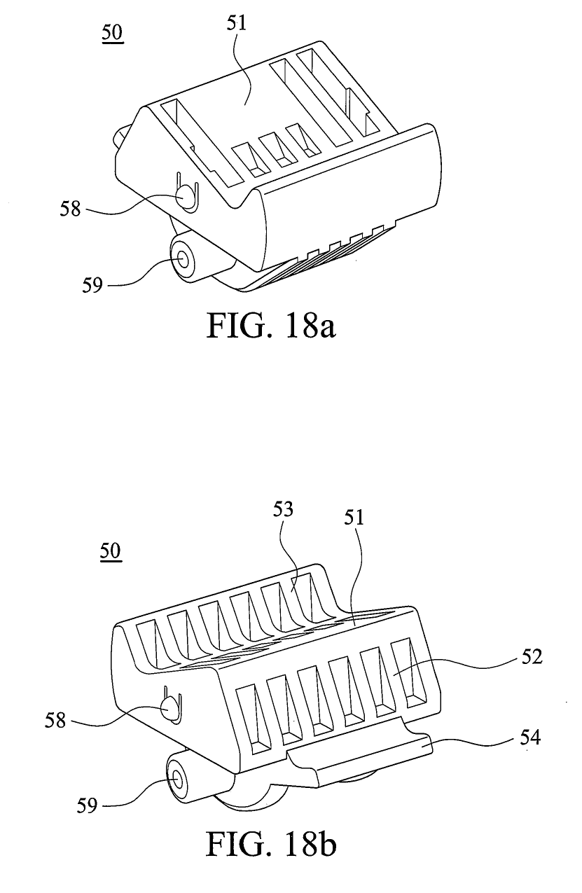

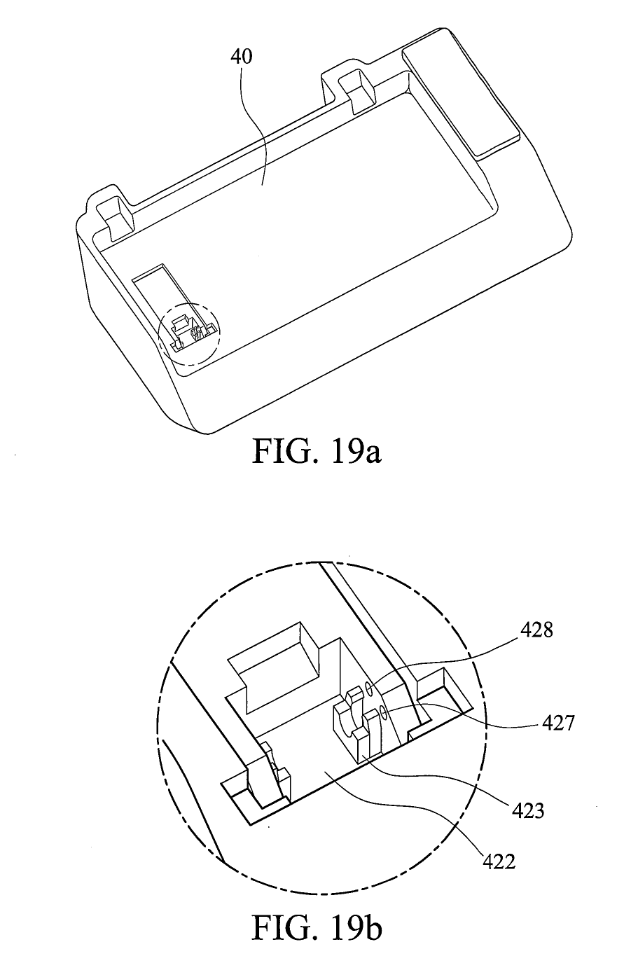

In addition to the extension spring, the cam 50 can be positioned in the first and second positions by other mechanisms. For example, in FIGS. 18a and 18b, a pair of protrusions 58 are disposed on the lateral wall of the cam 50, grooves 427 and 428 corresponding to the first and second positions are formed on the lateral wall of the second accommodation portion 422 as shown in FIGS. 19a and 19b. When the cam 50 rotates to the first position, the protrusion 58 engages the groove 427. When the cam 50 rotates to the second position, the protrusion 58 engages the groove 428.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multi-function printer, comprising:
a printing module having a accommodation portion and a supporting groove;
a scanning module rotatably disposed on the printing module;
a supporter rotatably disposed on the scanning module; and
a cam rotatably disposed in the accommodation portion and rotating between a first position and a second position, wherein when the scanning module is rotated and opened, the cam rotates and guides the supporter to abut the supporting groove, whereby the scanning module is supported on the printing module, and when the scanning module is rotated and closed, the cam rotates and guides the supporter to enter the accommodation portion.

2. The multi-function printer as claimed in claim 1, wherein the cam has a first guide surface and a second guide surface, and when the scanning module is rotated and opened, the supporter slides on the first guide surface to abut the supporting groove, and when the scanning module is rotated and closed, the supporter slides on the second guide surface to enter the accommodation portion.

3. The multi-function printer as claimed in claim 2, wherein the first guide surface is adjacent to the second guide surface.

4. The multi-function printer as claimed in claim 2, wherein the cam further comprises a first against surface adjacent to the first guide surface and a second against surface adjacent to the second guide surface, and when the scanning module is rotated and opened, the supporter slides from the first guide surface to the first against surface to rotate the cam to the first position, whereby the supporter is guided to abut the supporting groove, and when the scanning module is rotated and closed, the supporter slides from the second guide surface to the second against surface to rotate the cam to the second position, whereby the supporter is guided to enter the accommodation portion.

5. The multi-function printer as claimed in claim 4, wherein the cam further comprises a first positioning surface and a second positioning surface, and when the supporter is positioned in the supporting groove, the cam rotates to the first position and the first positioning surface abuts the accommodation portion, and when the supporter is guided to abut the accommodation portion, the cam rotates to the second position and the second positioning surface abuts the accommodation surface.

6. The multi-function printer as claimed in claim 5, wherein the first positioning surface is adjacent to the first against surface, and the second positioning surface is adjacent to the second against surface.

7. The multi-function printer as claimed in claim 5 further comprising an elastic element connecting the cam and the accommodation portion, wherein when the cam rotates to the first position, the first positioning surface abuts the accommodation portion by the elastic element, and when the cam rotates to the second position, the second positioning surface abuts the accommodation portion by the elastic element.

8. The multi-function printer as claimed in claim 7, wherein the elastic element is an extension spring.

9. The multi-function printer as claimed in claim 5, wherein the cam further comprises a positioning element, and the accommodation portion comprises a first groove and a second groove corresponding to the first position and the second position respectively, and when the cam rotates to the first position, the positioning element engages the first groove, whereby the first positioning surface abuts the accommodation portion, and when the cam rotates to the second position, the positioning element engages the second groove, whereby the second positioning surface abuts the accommodation portion.

10. The multi-function printer as claimed in claim 9, wherein the positioning element is a protrusion projecting from the cam.

11. The multi-function printer as claimed in claim 1, wherein the accommodation portion is adjacent to the supporting groove.

12. The multi-function printer as claimed in claim 1, wherein the cam further comprises a first positioning surface and a second positioning surface, and when the supporter is positioned in the supporting groove, the cam rotates to the first position and the first positioning surface abuts the accommodation portion, and when the supporter is guided to abut the accommodation portion, the cam rotates to the second position and the second positioning surface abuts the accommodation surface.

13. The multi-function printer as claimed in claim 12, wherein the accommodation portion comprises a first accommodation portion and a second accommodation portion under the first accommodation portion, and the supporter is accommodated in the first accommodation portion and the cam is accommodated in the second accommodation portion with a axle.

14. The multi-function printer as claimed in claim 13, wherein the second accommodation portion comprises a first surface and a second surface corresponding to the first positioning surface and the second positioning surface, and when the can is in the first position, the first positioning surface abuts the first surface, and when the cam is in the second position, the second positioning surface abuts the second surface.
